(19) United States
(12) Patent Application Publication
(10) Pub. No.: US 2006/0195665 A1
(43) Pub. Date: Aug. 31, 2006

(54) Access control device, method for changing memory addresses, and memory system

(75) Inventor: Koji Aoki, Kamakura-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/345,388

(22) Filed: Feb. 2, 2006

(30) Foreign Application Priority Data
Feb. 25, 2005 (JP) 2005-051369

(51) Int. Cl. G06F 12/00; G06F 12/06; G06F 13/00

(52) U.S. Cl. 711/154; 711/5

(57) ABSTRACT

A memory control device detects memory accesses and communicates with a plurality of memory modules that are serially connected. The memory control device changes the allocation of addresses for the plurality of memory modules in accordance with the detection of memory accesses in the detection step.

### FIELD OF THE INVENTION

The present invention relates to an access control device, a method for changing memory addresses, and a memory system.

### BACKGROUND OF THE INVENTION

Accompanying improvements in semiconductor technology in recent years, internal operating frequencies of processors and LSIs are being speeded up dramatically. Enhancement of operating frequencies is also required for memories that are externally connected to LSIs, particularly main storage memories using DRAMs, and the speeding-up of memory modules has been proceeding in recent years.

Under these circumstances, it has also become necessary to change the structure and configuration of memory modules that use DRAMs in response to this speed enhancement. Conventionally, for PC 133 (standard for SDRAM operating at 133 MHz clock frequency and DIMM for inserting the same) memory modules and the like, in an unbuffered configuration (configuration in which a buffer chip is not connected (used)), even if both commands and data were distributed with signals output from a controller as they are to a memory module inside a module, a problem did not arise. However, with DDR 400 (one of the DDR SDRAM standards, which is a specification corresponding to memory clocks up to 400 MHz (200 MHz DDR)) memory modules and the like, the following problem arises.

That is, when a configuration includes a plurality of DDR 400 memory modules or the like, the signal load on the board increases when command system signals are distributed and supplied to a large number of memory modules. As a result, signal transmission delays increase and high-speed operation cannot be guaranteed with an unbuffered configuration.

Therefore, command system signals are latched to a register mounted inside each memory module, and the signal load on the board is reduced by distributing the signals to each memory module to guarantee high-speed operation.

Since the signal load of data on the board at this time was small in comparison to command system signals, it had little influence on high-speed operation.

However, when constructing a system configured using a plurality of memory modules that enable realization of even faster speeds, such as DDR2/DDR3, it is no longer possible to ignore the load on the board caused by the distribution of each data signal, and it has an effect on high-speed operation.

As a mechanism for guaranteeing this high-speed operation, for example, a mechanism as shown in FIG. 14 is being studied with a view toward realization. In FIG. 14, using “point-to-point” high-speed serial interface technology, when transmission of commands and data is performed the commands and data are temporarily subjected to buffering with buffers inside the respective memory modules, and then transmitted. Hereunder, the operation of a memory module of this configuration will be described using FIG. 14.

A memory command issued from a memory control circuit 1401 is transmitted to buffers 1411 inside memory modules 1406 to 1409. Each buffer 1411 decides whether the access is to its own module or to another module. If the access is to its own module, the buffer distributes the command to a DRAM 1410 within the module. If the access is to another module, it transmits the command to the next module.

Write data is transmitted together with a memory command. For read data, the data is transmitted through the buffer 1411 in the opposite direction of a memory command to the memory control circuit 1401 side.

In the configuration shown in FIG. 14, commands and data are transmitted serially between the connected modules, and thus the arrival cycle of commands or write data to modules that are at a further distance from the LSI is delayed. Further, for read data the latency from modules that at a further distance from the LSI tends to become longer.

For example, for a memory access to the memory module 1406 that is nearest to the memory control circuit 1401 shown in FIG. 14, the memory access latency is the amount for one column of the buffer 1411 for a command or write data, and is also the amount for one column for read data.

For a memory access to the memory module 1409 that is furthest from the memory control circuit 1401, the memory access latency is the amount for four columns of the buffer 1411 for a command or write data, and is also the amount for four columns for read data. Thus, the access latency varies greatly according to the physical location of the memory module.

In contrast to the above described system shown in FIG. 14, in a system using the conventional memory modules as shown in FIG. 15, a command or data is distributed to each of memory modules 1506 to 1509. Accordingly, the access latency is uniform for each of DRAMs 1510, and irrespective of which area a memory access is issued to, the access performance is uniform.

However, when using the memory modules as shown in FIG. 14, the access latency varies significantly depending on the memory module to be accessed.

For example, in FIG. 14, the access response differs greatly between a case in which a large number of memory accesses are issued to the memory module 1406 and that in which a large number of memory accesses are issued to the memory module 1409. Therefore, the system performance will be significantly influenced by the type of memory accesses.

### SUMMARY OF THE INVENTION

The present invention was made to solve the above problem, and an object of this invention is to prevent a decrease in access performance to a memory module that is capable of high-speed operation.

Another object of this invention is to provide a memory control device comprising: detection means for detecting a memory access; communication means for communicating with a plurality of memory modules that are serially connected; and change means for changing allocation of addresses for the plurality of memory modules in accordance with detection of memory accesses by the detection means.

A further object of this invention is to provide a method for changing memory addresses comprising: a detection step of detecting a memory access; a communication step of communicating with a plurality of memory modules that are serially connected; and a change step of changing allocation of addresses for the plurality of memory modules in accordance with detection of memory accesses in the detection step.

A still further object of this invention is to provide a memory system having a memory controller and a plurality of memory modules that are serially connected to the memory controller, wherein the memory controller changes allocation of addresses for the plurality of memory modules in accordance with detection of memory accesses.

Other objects of this invention will be apparent from the description of the embodiments below.

### BRIEF DESCRIPTION OF THE DRAWINGS

FIG. 1 is a view showing an example of the configuration of a memory system of the first embodiment herein;

FIG. 2 is a view showing an example of the configuration of a memory control circuit 101 of the first embodiment;

FIGS. 3A and 3B are views showing configuration and setting examples of a memory information register 205 of the first embodiment;

FIG. 4 is a view showing an address map of a memory module;

FIG. 5 is a view showing an example of the configuration of a memory control circuit 501 of the second embodiment herein;

FIG. 6 is a view showing an example of the configuration of an access counter 505 that is shown in FIG. 5;

FIG. 7 is a view showing memory modules and banks that correspond to respective memory areas, and specific examples of a memory access count;

FIG. 8 is a view showing a correlation between physical addresses and addresses on a chip;

FIG. 9 is a view showing the correlation between physical addresses and addresses on a chip after conversion;

FIG. 10 is a view showing an example of the configuration of a memory control circuit 1001 of the third embodiment herein;

FIG. 11 is a view showing an example of the configuration of a page transition counter 1005 shown in FIG. 10;

FIG. 12 is a view showing memory modules and banks that correspond to respective memory areas, and specific examples of a page transition count;

FIG. 13 is a view illustrating the copying of memory data according to the fourth embodiment herein;

FIG. 14 is a view showing an example of the configuration of a system using memory modules capable of high-speed operation; and

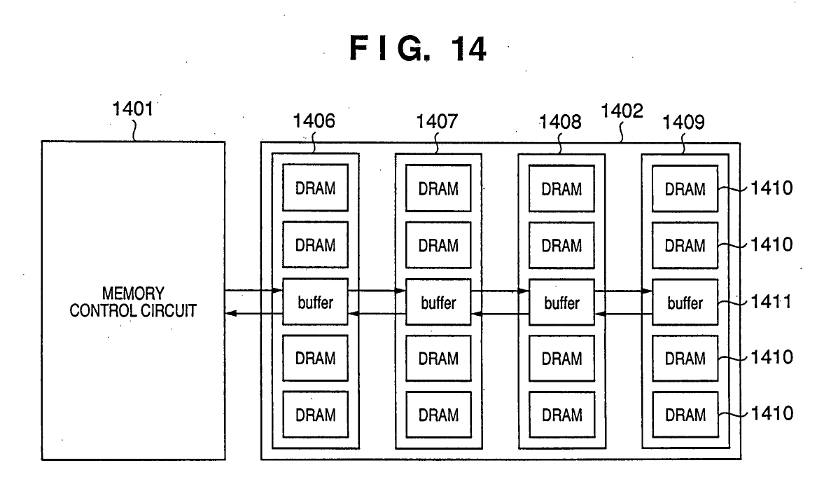

FIG. 15 is a view showing an example of the configuration of a system using conventional memory modules.

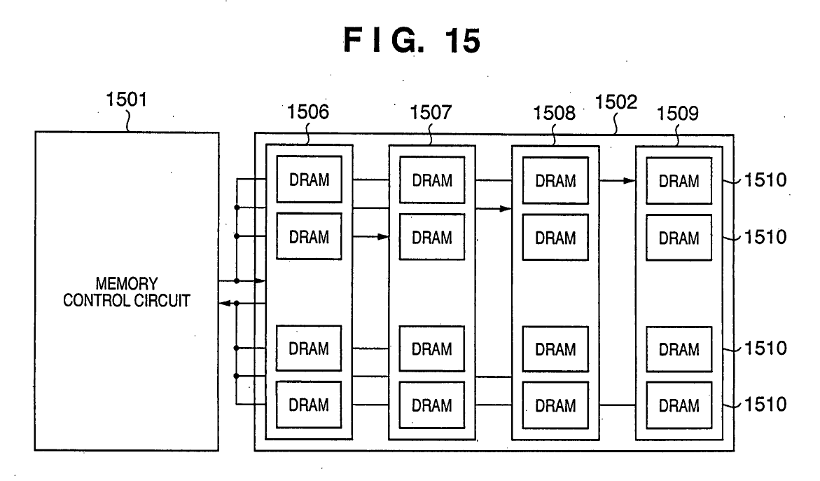

### DETAILED DESCRIPTION OF THE PREFERRED EMBODIMENTS

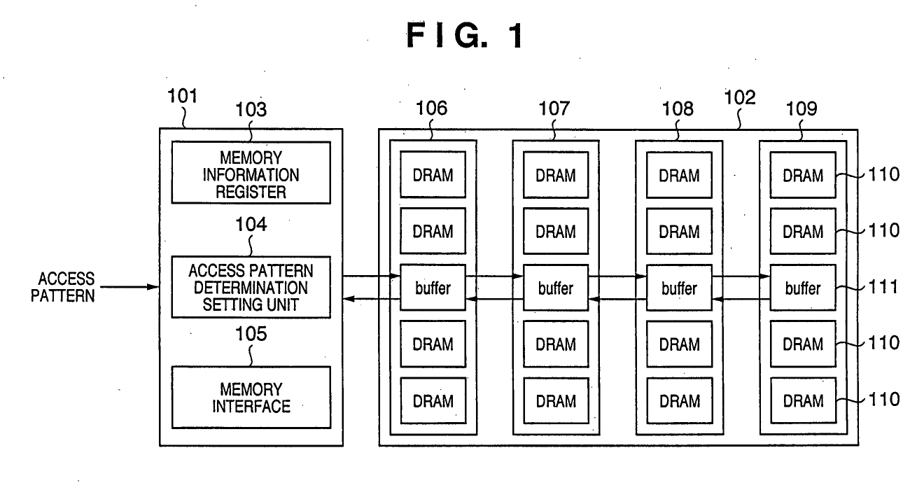

Hereunder, modes for implementing this invention are described in detail while referring to the drawings. The embodiments are described taking the following system as an example. More specifically, in the system of the embodiments, four sets of memory modules 106 to 109 are connected in a chain form from the memory control circuit 101 shown in FIG. 1. In this system, each memory module has a plurality of DRAMs 110 and a buffer 111 that receives commands and data and transmits them downstream.

In this example, the access latency is smallest for the memory module 106 whose physical location is nearest the memory control circuit 101, and the access latency is greatest for the memory module 109 whose physical location is furthest from the memory control circuit 101.

### First Embodiment

FIG. 1 is a view showing an example of the configuration of a memory system of the first embodiment. In the first embodiment, the memory control circuit 101 includes a memory information register 103, an access pattern determination setting unit 104 and a memory interface 105.

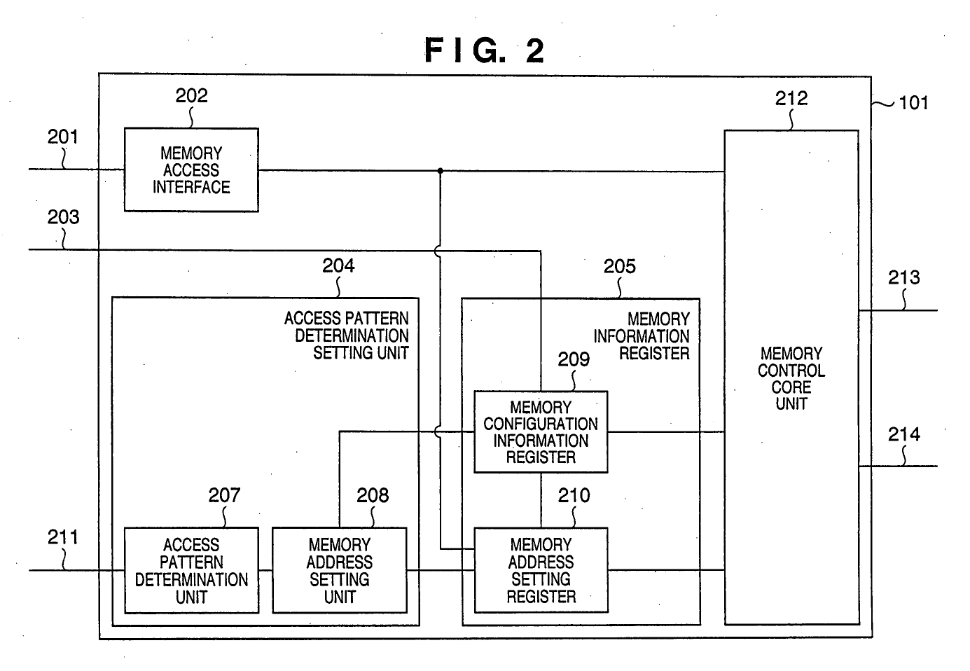

The configuration and control of the memory control circuit 101 of the first embodiment will be described using FIG. 2.

FIG. 2 is a view showing an example of the configuration of the memory control circuit 101 of the first embodiment. In FIG. 2, reference numeral 202 denotes a memory access interface which exchanges access commands and data with each of memory modules 106 to 109 of a memory module unit 102 through a memory access bus 201. Reference numeral 205 denotes a memory information register which stores operation settings or states of each of the memory modules 106 to 109 of the memory module unit 102 through a register access bus 203.

The memory information register 205 is composed by a memory configuration information register 209 and a memory address setting register 210. The memory configuration information register 209 designates and holds the access latency of a lead time to each of the memory modules 106 to 109. The memory address setting register 210 designates the memory space and address allocation of each of the memory modules 106 to 109.

Reference numeral 204 denotes an access pattern determination setting unit which inputs the contents of accesses that were made to each of the memory modules 106 to 109 as an access pattern 211, and sets the memory information register 205 based on the result of that analysis. The access pattern determination setting unit 204 consists of an access pattern determination unit 207 that determines an access pattern 211 to the memory, and a memory address setting unit 208.

The access pattern determination unit 207 analyzes the access contents of accesses that were made to the memory based on the input access pattern 211. The memory address setting unit 208 then decides the allocation of physical addresses of each of the memory modules 106 to 109 and memory space on the chip based on the results of that analysis.

Reference numeral 212 denotes a memory control core unit which controls the memory access contents to each DRAM 110 of each of the memory modules 106 to 109. In accordance with an access instruction from a CPU that is not shown in the figure, the memory control core unit 212 receives a memory write data 213 to be written in the memory module unit 102 and sends a memory read data 214 that was read from the memory module unit 102.

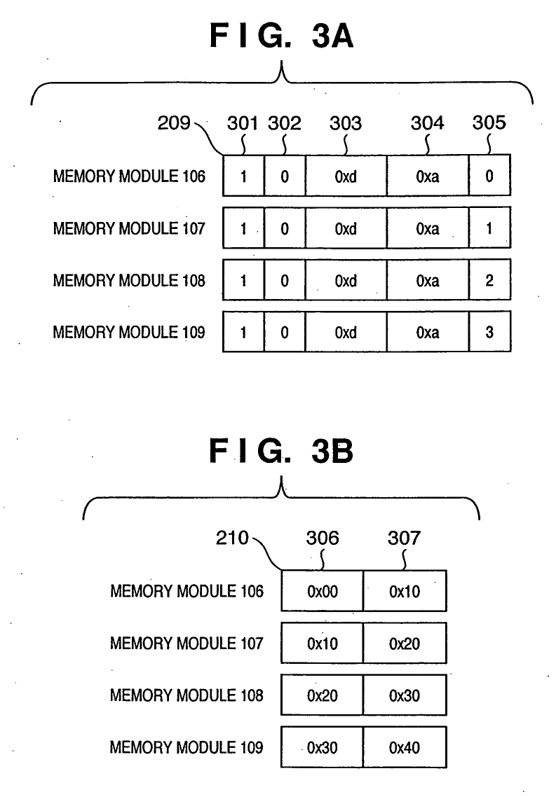

The configuration of the memory information register 205 will now be described using FIGS. 3A and 3B. In the first embodiment the four sets of memory modules 106, 107, 108 and 109 are connected to the memory control circuit 101. Accordingly, the memory configuration information register 209 and memory address setting register 210 of the memory information register 205 have four sets of corresponding register areas.

FIGS. 3A and 3B are views showing configuration and setting examples of the memory information register 205 of the first embodiment. FIG. 3A is a view illustrating a configuration and setting example of the memory configuration information register 209, and FIG. 3B is a view illustrating a configuration and setting example of the memory address setting register 210.

The memory configuration information register 209 comprises five areas. A first area stores a flag 301 that represents whether a memory module is enabled or disabled as configuration information for the connecting memory module. In a second area, a number of memory banks 302 is set. A third area stores a number of row addresses 303 as address information. In a fourth area, a number of column addresses 304 is set. In a fifth area, physical distance information 305 is set as latency for each memory module.

For example, the number of memory banks 302 is set using a flag, with “0” indicating that a module of 4 banks is connected and “1” indicating that a module of 8 banks is connected. Further, the physical distance information 305 for each memory module is set in the order of “0”, “1”, “2” and “3” starting from the module among the memory modules 106 to 109 that is located at the shortest physical distance from the memory control circuit 101.

The memory address setting register 210 has a memory area lower address register field 306 and a memory area upper address register field 307. Designation of address areas is performed for each memory module by designating the MSB 8 bits of the start address of the lower limit area and the MSB 8 bits of the ending address of the higher limit area.

For example, when the configuration of a memory module is that the number of banks is 4, the number of row addresses is 13 and the number of column addresses is 10, the memory configuration information register 209 is set as shown in FIG. 3A. More specifically, based on the information that the number of banks is 4 the register setting value for the number of memory banks 302 is set to “0”, the register setting value for the number of row addresses 303 is set to “0xd” and the register setting value for the number of column addresses 304 is set to “0xa”.

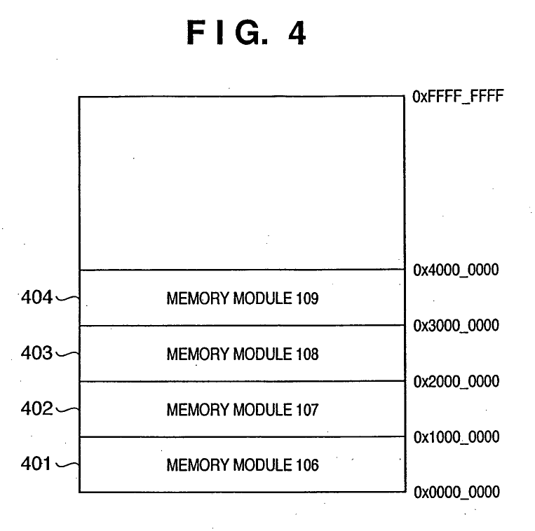

Further, when the memory address map is configured as represented by reference numerals 401 to 404 shown in FIG. 4, the memory address setting register 210 is set as shown in FIG. 3B. More specifically. “0x00”, and “0x10”, “0x10”, and “0x20”, “0x20”, and “0x30”, and “0x30”, and “0x40”, are set, respectively, in the memory area lower address register field 306 and the memory area upper address register field 307 that correspond to the respective memory modules 106 to 109 of the memory address setting register 210.

Next, a process is described for performing settings in the memory information register 205 based on the access pattern 211 input by the access pattern determination setting unit 204.

As the access pattern 211, the access pattern determination setting unit 204 inputs access contents that show the addresses of which areas of the memory modules 106 to 109 are being read or written to. Based on results obtained by analyzing the access contents, the access pattern determination setting unit 204 then generates and sets a write value for the memory configuration information register 209 and the memory address setting register 210 of the memory information register 205.

More specifically, when the access pattern determination unit 207 determines from the input access pattern 211 that it is better that the memory module 108 is at a physically shorter distance to the memory control circuit 101 than the memory module 106, the memory configuration information register 209 is set in the following manner. That is, the memory address setting unit 208 generates a value 2 to be written in the physical distance information 305 of the memory module 106 as an object for a memory address change, and generates a value “0” to be written in the physical distance information 305 of the memory module 108. It then sets the values generated in this manner in the memory configuration information register 209 as new memory address setting values.

By analyzing the access pattern 211 as described above, the memory spaces on a chip and addresses to be allocated to each memory module are changed in accordance with information regarding access frequency to the memory. Therefore, in a memory system in which access latency of the read time is different for each memory module, it is possible to suppress latency increases of the memory control circuit 101, to thereby prevent a decline in memory access performance.

In the first embodiment, the access pattern determination unit 207 and the memory address setting unit 208 can also be implemented by use of software.

For example, the access pattern determination unit 207 and the memory address setting unit 208 can be implemented by software such as a program, and not by a hardware circuit as shown in FIG. 2. In that case, the processing contents of the access pattern determination unit 207 and the memory address setting unit 208 are implemented by a processor.

Further, when processing with software, a configuration may be employed in which a new memory address value is directly written in the memory address setting register 210 as the implementation result of the memory address setting unit 208. In particular, when implementing a circuit with software it is possible to reduce the size of the hardware circuit and, similarly to the case of configuring the circuit using hardware, the memory allocation of addresses can be changed in a memory system with different access latencies. It is also possible to prevent a decline in memory access performance.

According to the first embodiment, in a memory control circuit for a memory in which access latency differs for each memory module, the memory space and address allocation of each memory module is changed in accordance with an access pattern. It is therefore possible to prevent a decline in memory access performance caused by an increase in latency.

### Second Embodiment

Next, a second embodiment of this invention will be described in detail while referring to the drawings.

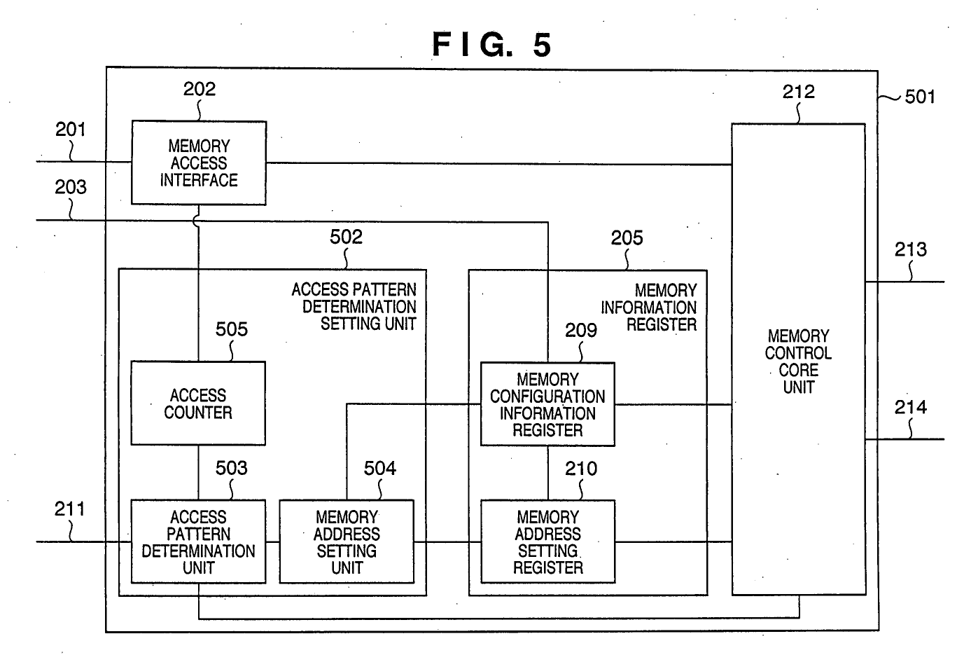

FIG. 5 is a view showing an example of the configuration of a memory control circuit 501 of the second embodiment. Components having the same functions as components in FIG. 2 that was used for the first embodiment are denoted by the same symbols as in FIG. 2, and a description thereof is omitted here. The configuration of the memory system of this embodiment is also the same as in FIG. 1.

In FIG. 5, reference numeral 502 denotes an access pattern determination setting unit of the second embodiment. The access pattern determination setting unit 502 comprises an access pattern determination unit 503 and a memory address setting unit 504 that correspond, respectively, to the access pattern determination unit 207 and the memory address setting unit 208 shown in FIG. 2. The access pattern determination setting unit 502 also comprises an access counter 505 that detects the access frequency to the memory module.

The configuration and operations of the access counter 505 of the second embodiment will now be described. The access counter 505 is a counter of N bits (N is an arbitrary natural number) that is incremented by one each time a memory access request is received by the memory control core unit 212, and when the count value reaches the maximum value it starts to count from 0 once again. The interval until the count value reaches the maximum value from 0 is considered an access measurement unit.

The access counter 505 has memory access counters that correspond to the number of partitioned areas in accordance with the number of memory modules and number of banks of the respective memory modules.

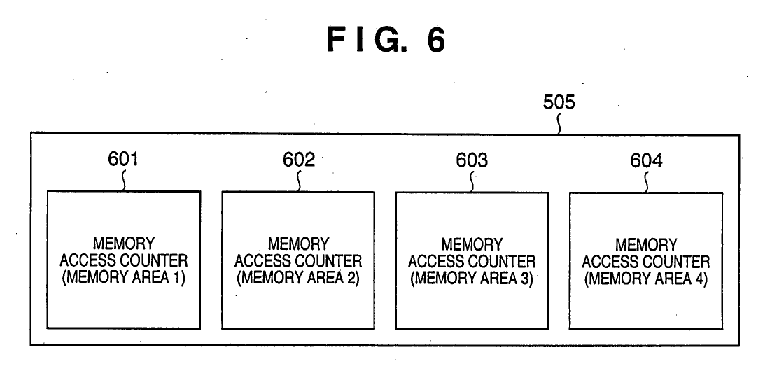

More specifically, as shown in FIG. 6, the access counter 505 is composed by a plurality of memory access counters that correspond to memory modules and banks, respectively. That is, a memory access counter 601 corresponds to a bank 0 of the memory module 106 and a memory access counter 602 corresponds to a bank 0 of the memory module 107. Further, a memory access counter 603 corresponds to a bank 0 of the memory module 108 and a memory access counter 604 corresponds to a bank 0 of the memory module 109.

Accordingly, when the memory consists of four memory modules that each comprise four banks, as in the present embodiment, a total of 16 counters are provided as the memory access counter 505.

By measuring the memory access frequency for each bank of each memory module, memory module areas that should be disposed at positions that are physically closer to the memory control circuit are detected, and this information is utilized as information for changing memory addresses to be allocated to the memory areas.

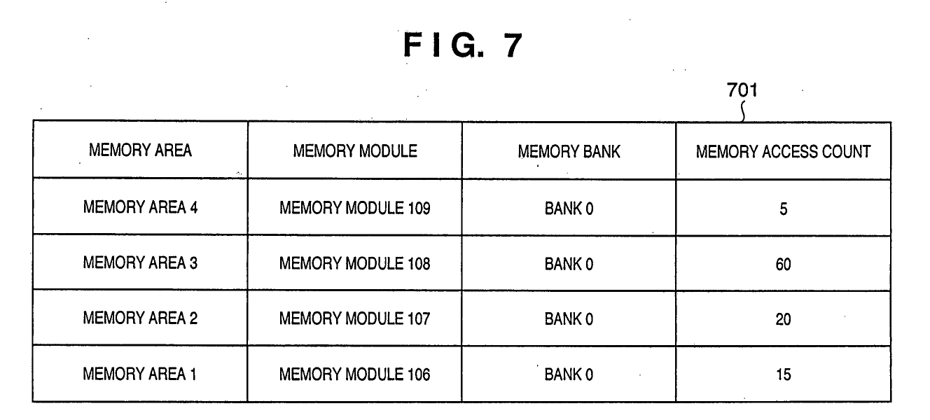

FIG. 7 is a view showing memory modules and banks that correspond to each memory area, and specific examples of a memory access count. To facilitate description, only bank 0 of each of the memory modules 106 to 109 is shown in FIG. 7.

In FIG. 7, memory area 1 to memory area 4 are defined as memory areas on a chip, and they are shown as corresponding with the bank 0 area of memory module 106 to the bank 0 area of memory module 109 as physical addresses. A memory access count 701 shows the number of times the memory at each memory address was activated.

More specifically, the example shown in FIG. 7 indicates that memory access occurred 15 times to the bank 0 area of the memory module 106 corresponding to memory area 1.

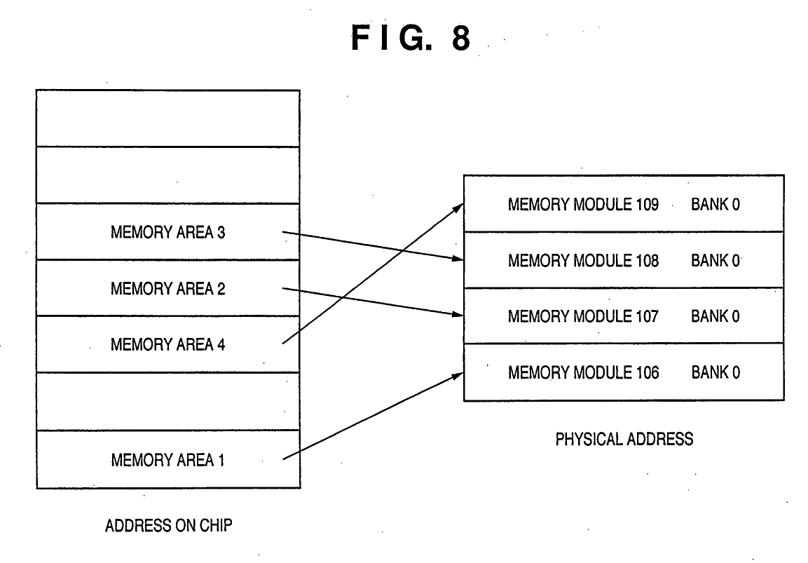

Further, if it is assumed that the correlation between the addresses on the chip and the physical addresses is, for example, as shown in FIG. 8, then accesses to the memory areas 1 to 4 as on-chip addresses result in accesses to the following physical addresses. That is, memory area 1 of the on-chip addresses accesses the bank 0 area of memory module 106 of the physical address, and memory area 2 accesses the bank 0 area of memory module 107. Further, memory area 3 accesses the bank 0 area of memory module 108 and memory area 4 accesses the bank 0 area of memory module 109.

Thus, according to the second embodiment, access latency is improved by converting a memory area with a large number of accesses to a memory address area that is physically near the memory control circuit based on the access counts 701 to the bank areas of the memory modules shown in FIG. 7.

That is, when there are many accesses to a memory module according to the memory access count, the address on the chip is changed to a memory module that is physically near the memory control circuit. Further, when there are few accesses to a memory module, the address on the chip is changed to a memory module that is physically far from the memory control circuit.

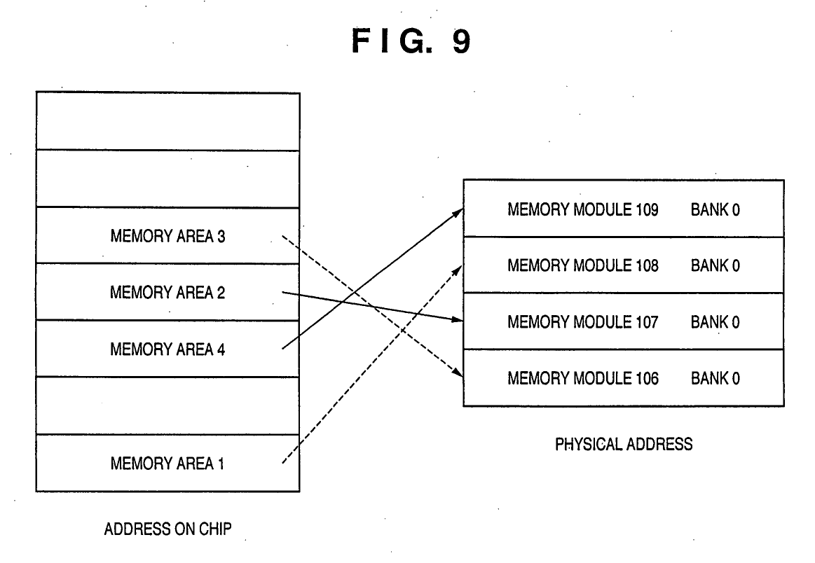

Specifically, in the case of the memory access counts 701 shown in FIG. 7, the correspondence between on-chip addresses and physical addresses shown in FIG. 8 is converted to the correspondence between on-chip addresses and physical addresses shown in FIG. 9. Accordingly, there is no change before and after conversion in memory area 2 and memory area 4 of the on-chip addresses, and they refer, respectively, to the bank 0 area of memory module 107 and the bank 0 area of memory module 109 of the physical addresses. However, memory area 1 is converted from the bank 0 area of memory module 106 to the bank 0 area of memory module 108. Further, memory area 3 is converted from the bank 0 area of memory module 108 to the bank 0 area of memory module 106 (indicated by the broken line in FIG. 9).

Thus, by appropriately changing the address allocation of physical addresses for on-chip addresses in accordance with the memory access count, it is possible to reduce a decline in performance caused by access latency.

According to the second embodiment, the number of memory accesses actually issued by the memory control circuit is calculated for each partitioned memory space, and the address allocation of a memory space to which a large number of memory accesses are issued is changed to that of a memory module with little latency. It is therefore possible to prevent a decline in memory access performance caused by latency increases in response to operating conditions.

### Third Embodiment

Next, the third embodiment of this invention will be described in detail while referring to the drawings.

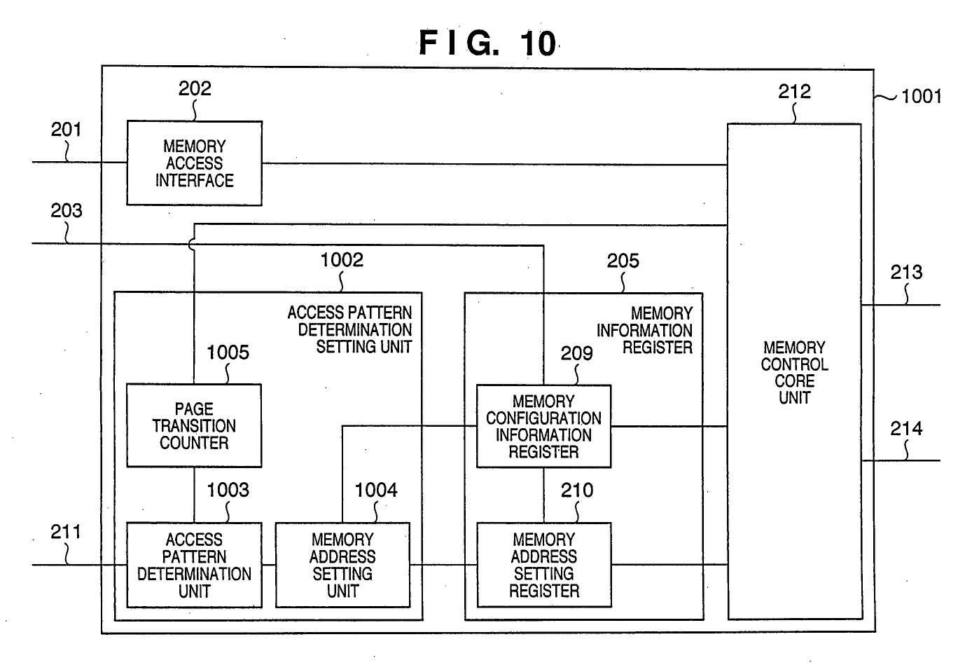

FIG. 10 is a view showing an example of the configuration of a memory control circuit 1001 of the third embodiment. Components having the same functions as components in FIG. 2 used in the first embodiment are denoted by the same symbols as in FIG. 2, and a description thereof is omitted here. The configuration of the memory system of this embodiment is also common with that of FIG. 1.

In FIG. 10, reference numeral 1002 denotes an access pattern determination setting unit of the third embodiment. The access pattern determination setting unit 1002 comprises an access pattern determination unit 1003 and a memory address setting unit 1004 that correspond to the access pattern determination unit 207 and memory address setting unit 208 shown in FIG. 2. The access pattern determination setting unit 1002 further comprises a page transition counter 1005 that counts the page transitions in a memory module.

The configuration and operation of the page transition counter 1005 of the third embodiment will now be described. The page transition counter 1005 is a counter of N bits (N is an arbitrary natural number) that counts the number of page transitions of each area of the memory module. More specifically, when a memory access request is received by the memory control core unit 212, it determines whether the page (the bank the address belongs to, and the row in the bank) of the relevant address is activated (open) or deactivated (closed). When the page is deactivated, the page transition counter 1005 decides that the access represents a page transition and increments the page transition count by one, and when the count value reaches the maximum value it starts the count from 0 once again. In this connection, the interval until the count value reaches the maximum value from 0 is considered an access measurement unit.

The page transition counter 1005 has page transition counters that correspond to the number of partitioned areas in accordance with the number of memory modules and the number of banks of each memory module.

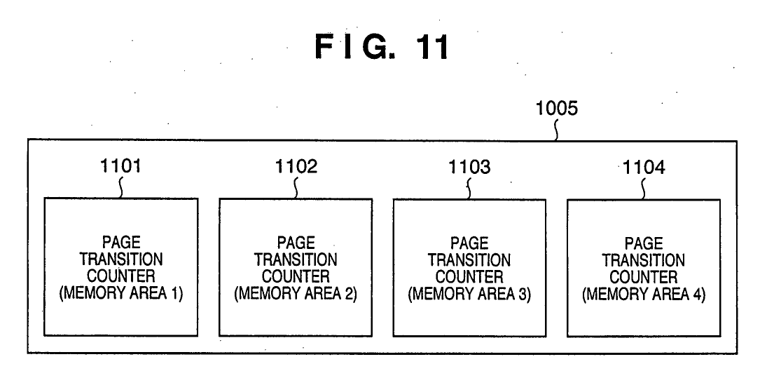

More specifically, as shown in FIG. 11, the page transition counter 1005 is composed of a plurality of page transition access counters that correspond to respective memory modules and banks as described hereunder. That is, a page transition counter 1101 corresponds to the bank 0 of memory module 106 and a page transition counter 1102 corresponds to the bank 0 of memory module 107. Further, a page transition counter 1103 corresponds to the bank 0 of memory module 108 and a page transition counter 1104 corresponds to the bank 0 of memory module 109.

Accordingly, when a memory consists of four memory modules that each comprise four banks, as in the present embodiment, a total of 16 counters are provided as the page transition counter 1005.

Thus, by calculating the page transition count for each bank of each memory module, a memory module area that should be disposed at a position that is physically closer to the memory control circuit is detected, and this information is utilized as information for changing the memory addresses to be allocated to the memory areas.

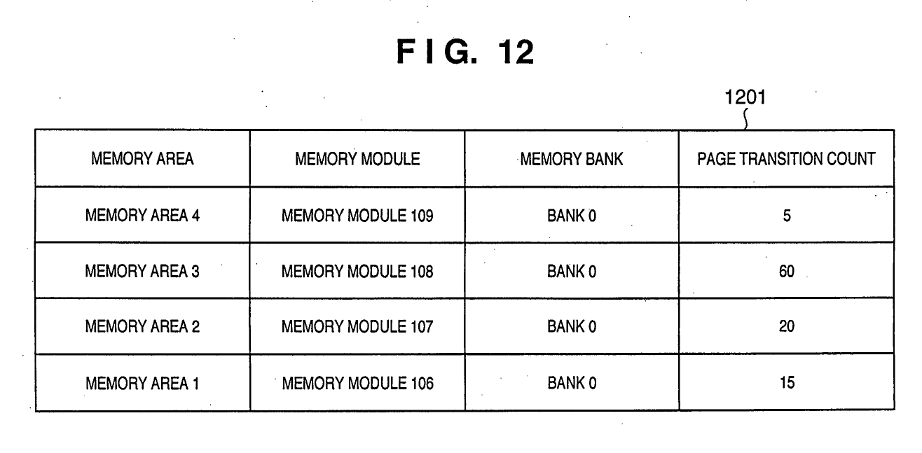

FIG. 12 is a view showing memory modules and banks that correspond to each memory area, and specific examples of a page transition count. To facilitate description, only bank 0 of each of the memory modules 106 to 109 is shown in FIG. 12.

In FIG. 12, memory area 1 to memory area 4 are defined as memory areas on a chip, and they are shown as corresponding with the bank 0 area of memory module 106 to the bank 0 area of memory module 109 as physical addresses. A page transition count 1201 for the memory at each memory address is also shown.

More specifically, the example shown in FIG. 12 indicates that page transition occurred 15 times for the bank 0 area of memory module 106 corresponding to memory area 1.

Further, if it is assumed that the correlation between addresses on the chip and physical addresses is, for example, as shown in FIG. 8 that was used for the second embodiment, accesses are then made as follows. That is, memory area 1 of the on-chip addresses accesses the bank 0 area of memory module 106 of the physical address, and memory area 2 accesses the bank 0 area of memory module 107. Further, memory area 3 accesses the bank 0 area of memory module 108, and memory area 4 accesses the bank 0 area of memory module 109.

Thus, according to the third embodiment, access latency is improved by converting a memory area with a large number of page transitions to a memory address area that is physically near the memory control circuit based on the page transition count 1201 for the bank areas of the memory modules shown in FIG. 12.

That is, when there are many page transitions for a memory module according to the page transition count, the on-chip address is changed to that of a memory module that is physically near the memory control circuit. Likewise, when there are few page transitions for a memory module, the on-chip address is changed to that of a memory module that is physically far from the memory control circuit.

Specifically, in the case of the page transition count 1201 shown in FIG. 12, the correspondence between addresses on the chip and physical addresses shown in FIG. 8 is converted to the correspondence between addresses on the chip and physical addresses shown in FIG. 9. Consequently, there is no change before and after conversion in the memory area 2 and memory area 4 of the addresses on the chip, and they refer, respectively, to the bank 0 area of memory module 107 and the bank 0 area of memory module 109 of the physical addresses. However, memory area 1 is converted from the bank 0 area of memory module 106 to the bank 0 area of memory module 108. Further, memory area 3 is converted from the bank 0 area of memory module 108 to the bank 0 area of memory module 106 (indicated by the broken line in FIG. 9).

When each memory module consists of a plurality of banks (a plurality of pages), the above described on-chip addresses are changed taking into consideration page transitions for the plurality of pages.

Thus, by appropriately changing the address allocation of on-chip addresses with respect to physical addresses in accordance with the page transition count for active areas and inactive areas of the memory, it is possible to reduce a decline in performance due to access latency.

According to the third embodiment, the number of page transitions actually issued by the memory control circuit is calculated for each partitioned memory space, and the address allocation of a memory space with a large number of page transitions is changed to that of a memory module with little latency. Accordingly, it is possible to lessen the influence of a page mistake penalty caused by a latency increase and also maintain the transfer width of memory space with few page transitions to realize optimal memory access performance.

### Fourth Embodiment

Next, the fourth embodiment of this invention will be described in detail while referring to the drawings.

In the first to third embodiments, when it was determined that a memory address change was required, the memory control core unit 212 stopped access to the memory and changed the address allocation for a physical address of an address on the chip. In the fourth embodiment, an operation that copies the data of a memory module is also performed.

The number of accesses to memory is counted for each memory module as shown in FIG. 7, and when the necessity arises to interchange the memory data of memory area 1 and the memory data of memory area 3 in accordance with the memory access count 701, the following replacement of memory data is performed. That is, replacement is executed of memory data contained in specific areas of memory modules determined by the memory area lower address register field 306 and the memory area upper address register field 307 of the memory address setting register 210.

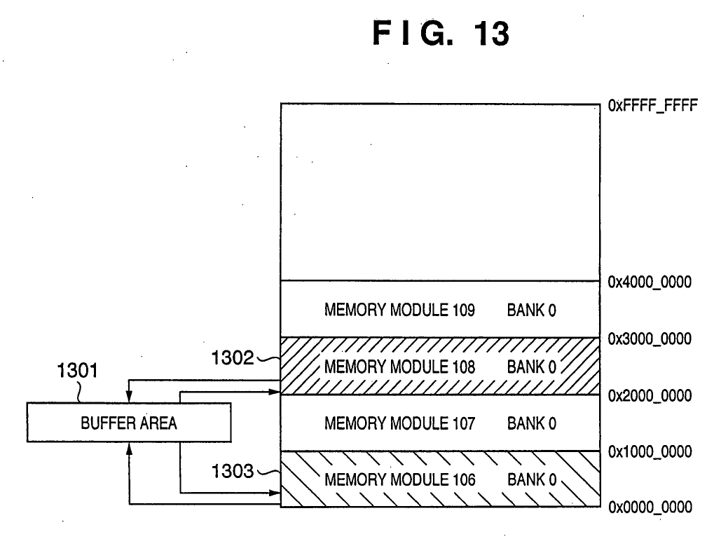

FIG. 13 is a view illustrating the copying of memory data according to the fourth embodiment. As shown in FIG. 13, when changing the allocation of the bank 0 area of memory module 108 and the bank 0 area of memory module 106, the memory data is duplicated in the following manner. That is, an arbitrary buffer area 1301 is provided for temporarily storing memory data, and the memory data of both the bank 0 area 1302 of memory module 108 and the bank 0 area 1303 of memory module 106 is temporarily duplicated. Thereafter, it is possible to preserve the interchangeability of the memory data by copying the memory data to the change destination memory address of the newly allocated memory module.

Accordingly, at a stage when an operation to copy data to the memory address that is the object of the memory address replacement is completed, the memory control core unit 212 restarts access to the memory module to enable reading of memory data at the new memory address without any trouble.

According to the fourth embodiment, by performing memory duplication when changing the address allocation of a memory space and memory module, after changing the allocation it is still possible to use the memory data that was stored in the relevant space prior to the change.

Note that the present invention can be applied to a system constituted by a plurality of devices (for example, a host computer, interface device, reader, printer or the like) or to an apparatus comprising a single device (for example, a copying machine or facsimile device).

Further, an object of this invention can also be achieved by supplying a storage medium on which is recorded the program code of software which implements the functions of the foregoing embodiments to a system or apparatus, reading the program code stored on the supplied storage medium with a computer (CPU or MPU) of the system or apparatus, and then executing the program code.

In this case, the program code itself that was read from the storage medium implements the functions of the foregoing embodiments, and the storage medium that stores the program code constitutes the present invention.

Examples of storage media that can be used for supplying the program code are a floppy disk (registered trademark), a hard disk, an optical disk, a magneto-optical disk, a CD-ROM, a CD-R, a magnetic tape, a non-volatile type memory card, and a ROM.

Furthermore, besides the case where the aforesaid functions according to the embodiments are implemented by executing the read program code by computer, an operating system or the like running on the computer may perform all or a part of the actual processing based on instructions of the program code so that the functions of the foregoing embodiments can be implemented by this processing.

Furthermore, after the program code read from the storage medium is written to a function expansion board inserted into the computer or to a memory provided in a function expansion unit connected to the computer, a CPU or the like mounted on the function expansion board or function expansion unit performs all or a part of the actual processing based on instructions of the program code so that the functions of the foregoing embodiments can be implemented by this processing.

Although the above description is based on preferred embodiments of the present invention, this invention is not limited to the above embodiments, and various modifications thereto are possible within the scope of the appended claims.

This application claims the benefit of Japanese Patent Application No. 2005-051369 filed on Feb. 25, 2005, which is hereby incorporated by reference herein in its entirety

What is claimed is:

1. A memory control device, comprising:
detection means for detecting a memory access;
communication means for communicating with a plurality of memory modules that are serially connected;
change means for changing an allocation of addresses for the plurality of memory modules in accordance with a detection of memory accesses by the detection means.

2. The device according to claim 1, wherein the change means changes addresses of the plurality of memory modules to be allocated to a plurality of memory areas, in accordance with a detection of memory accesses for each of a plurality of memory areas.

3. The device according to claim 1, wherein the change means changes an allocation of addresses for the plurality of memory modules in accordance with a detection of memory accesses for pages that were closed in the plurality of memory modules.

4. The device according to claim 1, wherein the change means writes data of an address prior to changing an allocation in an address after changing the allocation.

5. A method of changing a memory address, comprising:
a detection step of detecting a memory access;
a communication step of communicating with a plurality of memory modules that are serially connected; and
a change step of changing an allocation of addresses for the plurality of memory modules in accordance with a detection of memory accesses in the detection step.

6. The method according to claim 5, wherein the change step changes addresses of the plurality of memory modules to be allocated to a plurality of memory areas, in accordance with a detection of memory accesses for each of a plurality of memory areas.

7. The method according to claim 5, wherein the change step changes an allocation of addresses for the plurality of memory modules in accordance with a detection of memory accesses for pages that were closed in the plurality of memory modules.

8. The method according to claim 5, wherein the change step writes data of an address prior to changing an allocation in an address after changing the allocation.

9. A memory system comprising:
a memory controller; and
a plurality of memory modules that are serially connected to the memory controller;
wherein the memory controller changes an allocation of addresses for the plurality of memory modules in accordance with a detection of memory accesses.

10. The system according to claim 9, wherein the memory controller changes addresses of the plurality of memory modules to be allocated to a plurality of memory areas, in accordance with a detection of memory accesses for each of a plurality of memory areas.

11. The system according to claim 9, wherein the memory controller changes an allocation of addresses for the plurality of memory modules in accordance with a detection of memory accesses for pages that were closed in the plurality of memory modules.

12. The system according to claim 9, wherein the memory controller writes data of an address prior to changing an allocation in an address after changing the allocation.
